(19) United States
(12) Patent Application Publication
(10) Pub. No.: US 2004/0191120 A1
(43) Pub. Date: Sep. 30, 2004

(54) Automatic analysis apparatus

(75) Inventor: Tatsuya Yanagawa, Minami-ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/807,369

(22) Filed: Mar. 24, 2004

(30) Foreign Application Priority Data
Mar. 25, 2003 (JP) 082949/2003

(51) Int. Cl. G01N 35/00

(52) U.S. Cl. 422/63

(57) ABSTRACT

An automatic analysis apparatus includes a reading device for reading out element information attached to a dry analysis element. The element information added to the dry analysis element includes reagent type information defining a measuring item and reagent lot information for correcting reagent-lot-specific variations. The reader can read the reagent type information during reading the element information. The automatic analysis apparatus has an error handling function to calculate the analysis result based on pre-obtained analytical information corresponding to the reagent lot and add the a caution mark to the analysis result to attract attention, when the reagent lot information is not read out successfully. For the reagent type with little or no reagent-lot-specific variations, the analysis result is calculated by setting to disregard the reagent lot regardless of the reagent lot information read from the dry analysis element.

### BACKGROUND OF THE INVENTION

1. Field of the Invention

The present invention relates to an automatic analysis apparatus such as a biochemical analysis apparatus in which a sample such as blood or urine is spotted on a colorimetric dry analysis element or an electrolytic dry analysis element in order to determine the concentration, ion activity and the like of a specific biochemical component contained in the sample. Specifically, the present invention relates to a process for reading element information attached to a dry analysis element.

2. Description of the Related Art

Conventionally, there have been developed and practically implemented colorimetric dry analysis elements with which the content of a specific biochemical component or specific solid component contained in a sample liquid can be quantitatively analyzed by merely spotting a droplet of the sample thereon, and electrolytic dry analysis elements with which the activity of a specific ion contained in a sample liquid can be determined. Biochemical analysis apparatuses using such dry analysis elements are favorably used in medical institutions, laboratories and the like owing to their capability of analyzing samples easily and quickly.

The colorimetry method using calorimetric dry analysis elements is as follows: a droplet of a sample is spotted on a dry analysis element; the analysis element having the sample thereon is held at a constant temperature for a predetermined time in an incubator so that a coloring reaction (pigment forming reaction) occurs; the optical density of the color formed by the coloring reaction is optically measured by exposing the analysis element to measuring light, containing a wavelength which is pre-selected according to the combination of the component to be analyzed and the reagent contained in the analysis element; and the concentration of the component to be analyzed is determined on the basis of the optical density according to a calibration curve representing the relationship between the concentration of the specific biochemical component and the optical density. On the other hand, in the potentiometry method using an electrolytic dry analysis element, the activity of a specific ion contained in a sample spotted on an ion selective electrode pair of a dry analysis element is potentiometrically measured through the use of a reference solution, instead of measuring the optical density.

In either of colorimetry or potentiometry, the sample is held in a sample container (e.g., a blood-collecting tube) and set in the analysis apparatus, and an analysis element required for the measurement is also loaded in the apparatus. The dry analysis element is thus carried from the loaded position to a spotting station and then to an incubator, while the sample is delivered by a spotting nozzle from the set position to the spotting station where the dry analysis element is spotted with the sample.

The measuring item varies depending on the type of reagent that constitutes the dry analysis element. How to spot the dry analysis element and how to photometrically measure the sample vary depending on the reagent type and hence the measuring item. Therefore, each dry analysis element is attached with element information including its reagent type in the form of a bar code or the like. In performing a measurement with such a dry analysis element, the analysis apparatus takes the dry analysis element out of the sample tray, reads out the element information attached thereto, and performs a measurement operation according to the measuring item of the dry analysis element. Some reagents for the dry analysis elements may provide different measured values due to reagent-lot-specific variations. For example, Japanese Patent Publication No. 5(1993)-264535 discloses that a magnetic card storing therein reagent lot information for correcting such a reagent-lot-specific variation is attached to each package of dry analysis elements, and when a package of a new reagent lot is opened and used by the analysis apparatus, the attached card is read, the reagent-lot-specific variation is corrected, and then the analysis result is calculated.

It is contemplated to include reagent lot information in addition to the reagent type information in the element information to be attached to the dry analysis element. However, the greater the amount of information to be attached to a small dry analysis element, the greater the possibility that information readout errors will occur. Consequently, this could decrease the analysis processing efficiency associated therewith.

More specifically, if a readout error occurs during reading element information attached to a dry analysis element, the process interrupts the measurement. The element information is input separately, or the dry analysis element is replaced. Alternatively, the process is interrupted and skips the measurement of the dry analysis element relevant to the readout error, and starts measurement for a next dry analysis element. The sample that caused the interruption of measurement and is discontinued from the measurement is required to be measured anew by spotting this sample on a dry analysis element associated with the relevant measuring item. In either case, the measurement process becomes complex.

Further, for some reagents for the dry analysis elements, measurement deviations depending on reagent lot do not present problem in terms of accuracy. Similarly, in this case, setting the apparatus to interrupt the measurement or to perform re-measurement when the reagent lot information readout error occurs would lead to reduced processing efficiency.

### SUMMARY OF THE INVENTION

In view of the foregoing, an object of the present invention is to provide an automatic analysis apparatus which enables efficient measurement by eliminating re-measurement when a reagent lot information readout error occurs when element information including reagent lot information has been attached to a dry analysis element.

The first aspect of the present invention provides an automatic analysis apparatus for spotting a sample on a dry analysis element and analyzing the sample for its composition by measurement and calculation based on analytical information corresponding to element information attached to the dry analysis element, the automatic analysis apparatus comprising a reading device for reading out the element information, wherein:

the element information attached to the dry analysis element includes reagent type information defining a measuring item and reagent lot information for correcting reagent-lot-specific variations; the reading device can read out the reagent type information during reading of the element information; and the automatic analysis apparatus has an error handling function to calculate the analysis result based on pre-obtained analytical information corresponding to the reagent lot and to add a caution mark to the analysis result to attract attention, when the reagent lot information is not read out successfully.

Preferably, the automatic analysis apparatus further has a re-calculation function to re-calculate the analysis result when normal reagent lot information is input to correct the analysis result to which the caution mark was added.

The second aspect of the present invention provides an automatic analysis apparatus for spotting a sample on a dry analysis element and analyzing the sample for its composition by measurement and calculation based on analytical information corresponding to element information attached to the dry analysis element, the automatic analysis apparatus comprising a reading device for reading out the element information, wherein:

the element information attached to the dry analysis element includes reagent type information defining a measuring item and reagent lot information for correcting reagent-lot-specific variations; the element information readout processing by the reading device is previously set to disregard a reagent lot of a specific reagent type; and the automatic analysis apparatus further has a function to subject the dry analysis element, from which the reading device reads the reagent type information designated to disregard the reagent lot, to calculation processing for determining the analysis result based on pre-obtained analytical information irrespective of the condition when the reagent lot information is read.

In accordance with the first aspect of the invention as described above, the dry analysis element is attached with element information including reagent type information and reagent lot information, and the automatic analysis apparatus is provided with an error handling function to calculate the analysis result based on pre-obtained analytical information corresponding to the reagent lot when the reagent lot information readout error occurs, and to add the caution mark to the analysis result to attract attention. Owing to this, measurement is not interrupted even when a reagent lot information readout error occurs, and the need for re-measurement is avoided, such that efficient analysis processing is achieved. Further, occurrence of a readout error can be identified since a caution mark is attached to the analysis result that suffers the readout error, thereby improving reliability of the analysis result.

When the automatic analysis apparatus is further provided with a re-calculation function to re-calculate the analysis result when normal reagent lot information is input to correct the analysis result to which the caution mark was added, an analysis result with high measurement accuracy can be obtained without re-spotting and re-measuring the sample.

Meanwhile, the readout processing of the reading device for reading out the element information attached to the dry analysis element the automatic analysis apparatus further has a function to subject the dry analysis element, from which the reading device reads the reagent type information designated to disregard the reagent lot, to calculation processing for determining the analysis result based on pre-obtained analytical information, such that measurement is performed for the reagent type whose accuracy of the analysis result is not substantially affected by difference in reagent lot, irrespective of the condition when the reagent lot information is read. Owing to this, unnecessary interruption of analysis is avoided even when a readout error occurs, whereby an efficient measurement is achieved while maintaining good analysis accuracy.

### BRIEF DESCRIPTION OF THE DRAWINGS

FIG. 1 is a perspective view showing the external appearance of a biochemical analysis apparatus according to one embodiment of the present invention;

FIG. 2 is a front view, partially in cross section, showing the schematic construction of the biochemical analysis apparatus;

FIG. 3 is a plan view showing the mechanism of essential parts of the biochemical analysis apparatus in FIG. 2 in a position for transferring a dry analysis element, excluding a spotting device;

FIG. 4 is a cross-sectional elevation view showing a dry analysis element transfer path and its periphery of the biochemical analysis apparatus;

FIG. 5 is a schematic partial plan view of FIG. 3 with a sample tray being moved to a readout position;

FIG. 6A is a plan view and FIG. 6B is a bottom view of a dry analysis element; and

FIG. 7 is a flowchart of processing for reading element information attached to a dry analysis element.

### DESCRIPTION OF THE PREFERRED EMBODIMENTS

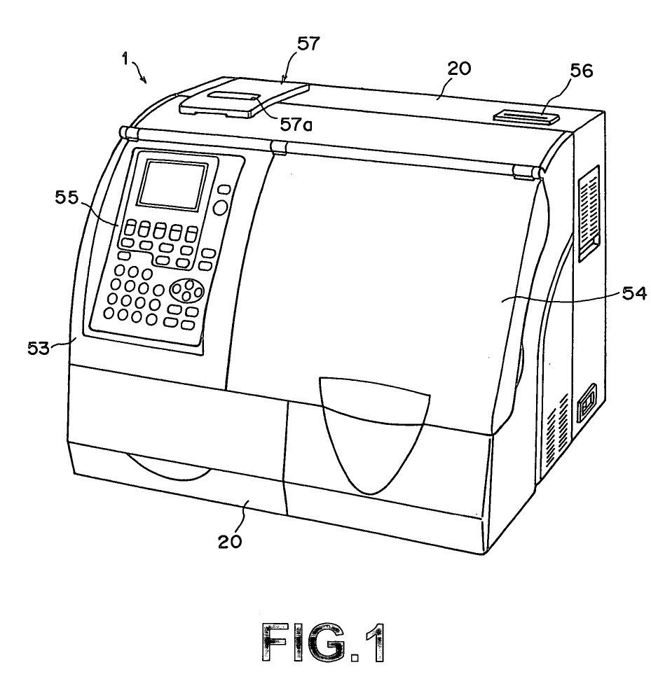

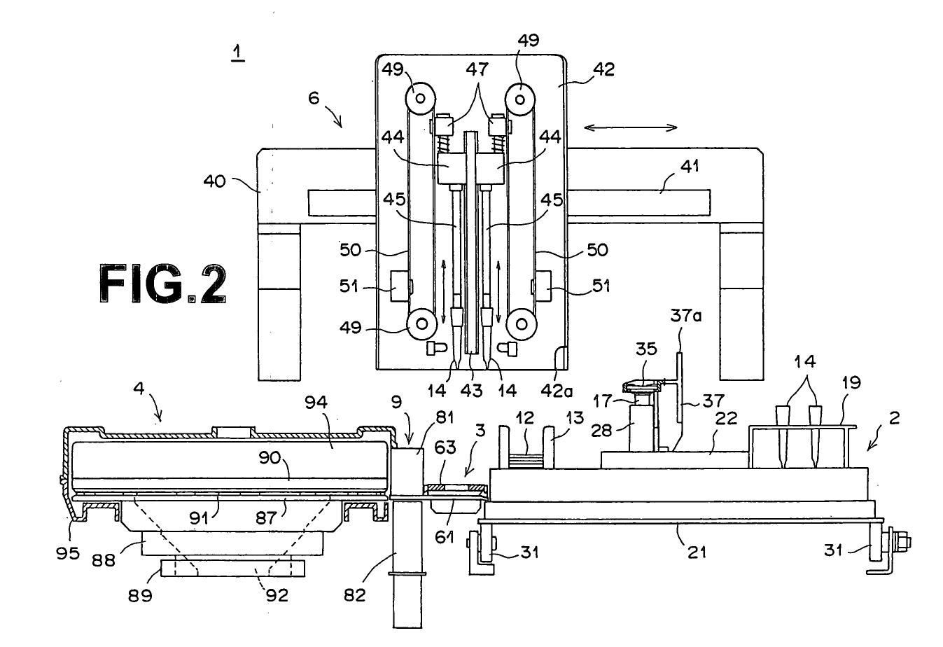

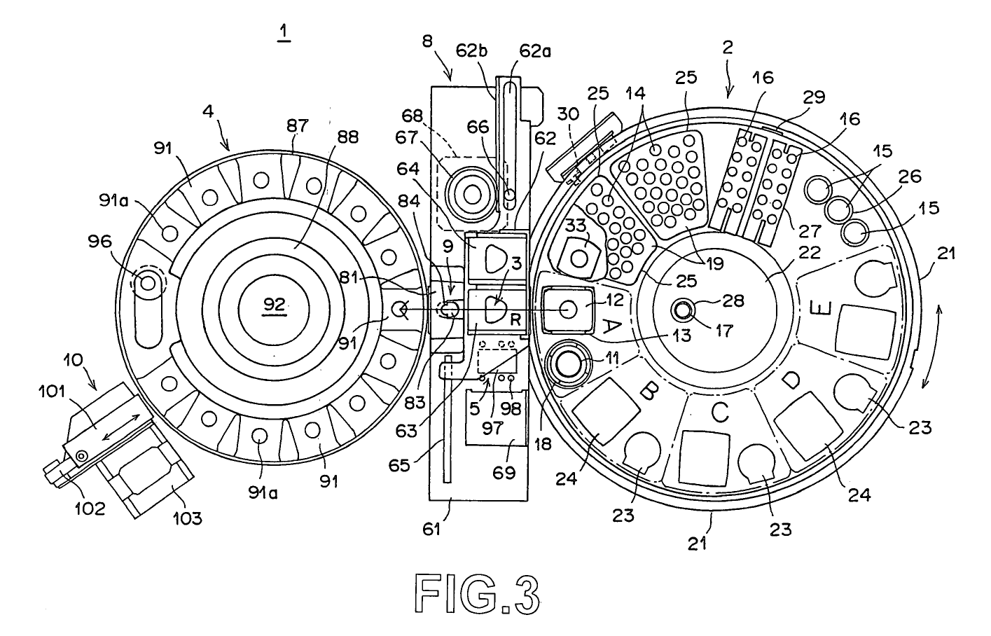

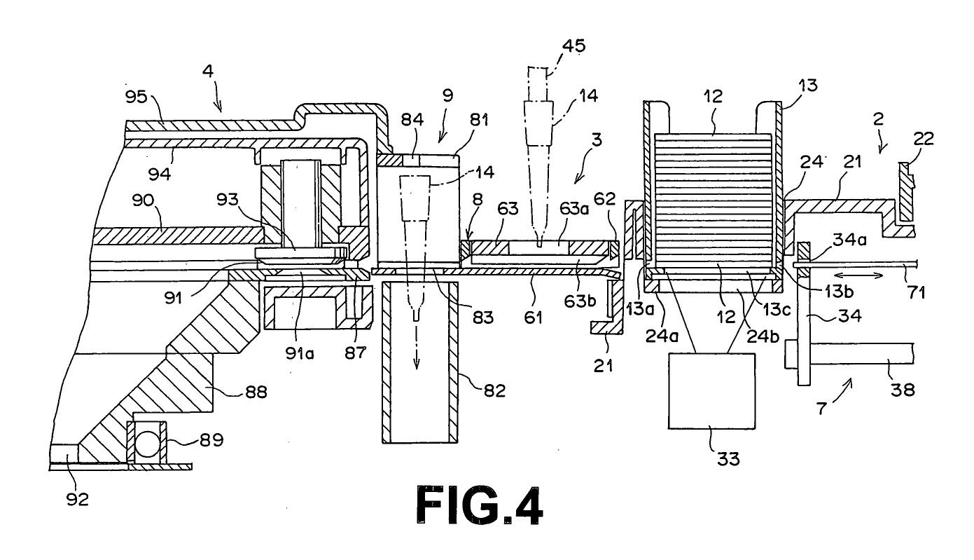

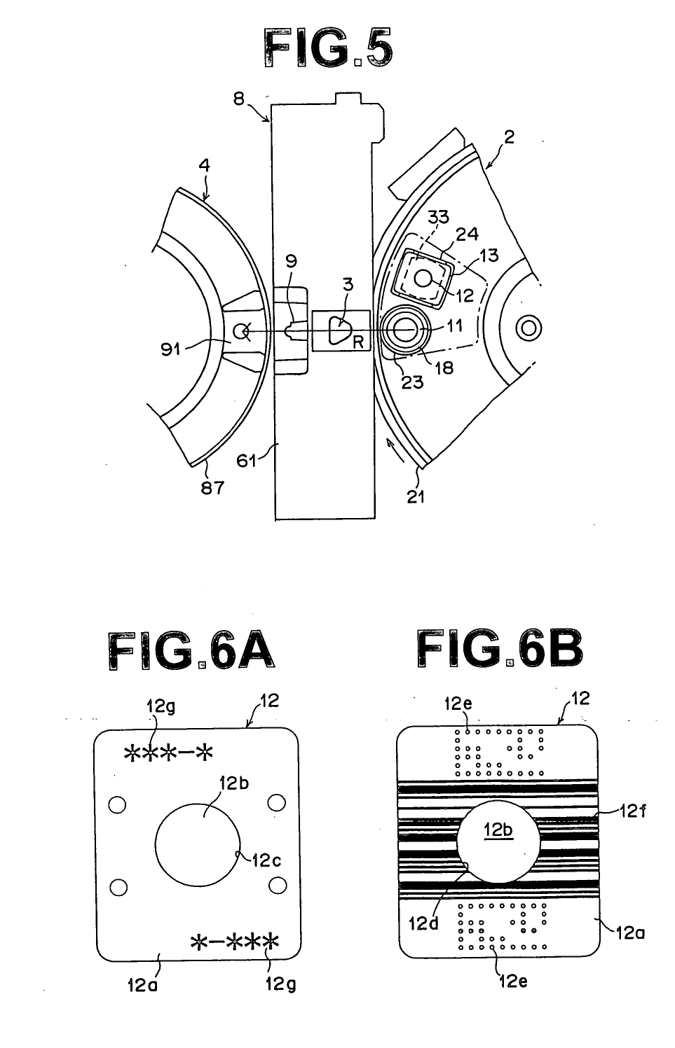

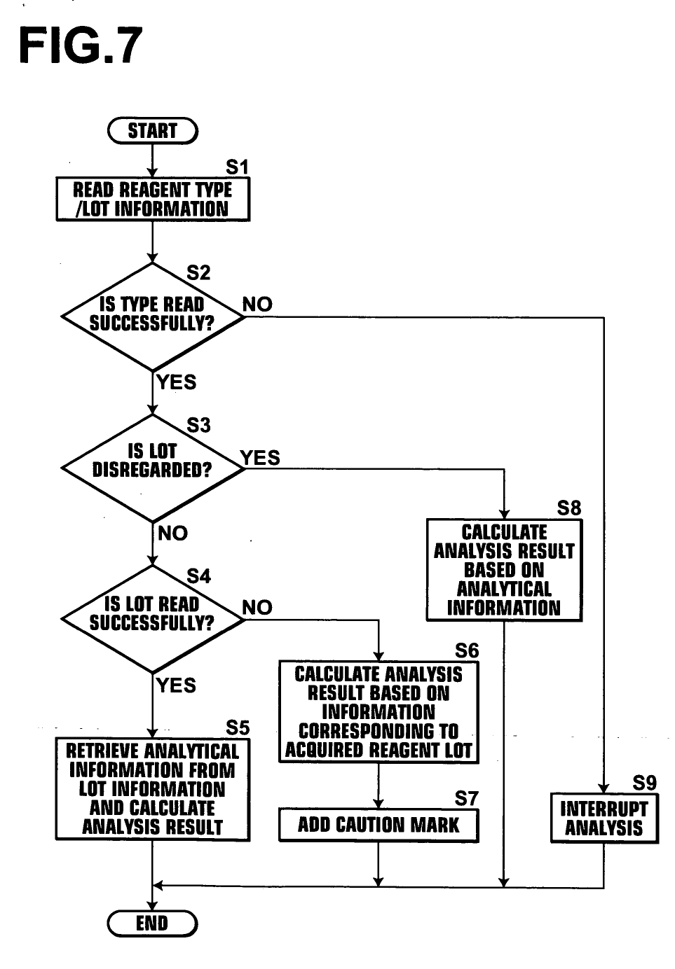

Hereinafter, preferred embodiments of the present invention will be described with reference to the drawings. As an illustrative automatic analysis apparatus according to the embodiment, a biochemical analysis apparatus will be described hereinafter with reference to the accompanying drawings. FIG. 1 is a perspective view showing the external appearance of a biochemical analysis apparatus according to one embodiment of the present invention, FIG. 2 is a front view, partially in cross section, showing the schematic construction of the biochemical analysis apparatus, FIG. 3 is a plan view showing the mechanism of essential parts of the biochemical analysis apparatus in a position for transferring a dry analysis element, FIG. 4 is a cross-sectional elevation view showing a dry analysis element transfer path and its periphery; FIG. 5 is a schematic partial plan view with a sample tray being moved to a readout position, FIG. 6A is a plan view and FIG. 6B is a bottom view of a dry analysis element, and FIG. 7 is a flowchart of readout processing.

First, a description of the general configuration of a biochemical analysis apparatus 1 will be given with reference to FIGS. 1 to 5. A measuring mechanism of this biochemical analysis apparatus 1 comprises a sample tray 2, a spotting station 3, a first incubator 4, a second incubator 5, a spotting mechanism 6, an element conveyance mechanism 7, a transfer mechanism 8, a tip disposal area 9, and an element discarding mechanism 10, etc.

The biochemical analysis apparatus 1 provided with the aforementioned mechanisms has an appearance as shown in FIG. 1 wherein the upper front part of a box-shaped cabinet 20 surrounding the components of the biochemical analysis apparatus 1 is covered by front left-hand and right-hand covers 53, 54. A control panel 55 is provided on the surface of the front left-hand cover 53. The first incubator 4 and the element discarding mechanism 10 are disposed within the lower part of the cabinet inside the front left-hand cover 53. On the other hand, the sample tray 2 made of a transparent material is disposed inside the front right-hand cover 54. The spotting station 3, the second incubator 5, the transfer mechanism 8, and a tip disposal area 9 are arranged between the sample tray 2 and the first incubator 4. Further, the spotting mechanism 6 is provided above the foregoing components so as to be movable right and left.

A printer 57 is provided at the top left part of the. cabinet 20. Printed recording paper (not shown) is discharged from the printer 57 through its paper discharging port 57a disposed on the upper surface of the cabinet 20. Meanwhile, a card reader 56 is provided at the top right part of the cabinet.

Hereinafter, a dry analysis element used for this invention will be described with reference to FIGS. 6A and 6B. FIGS. 6A and 6B illustrate a calorimetric dry analysis element 12 for measuring the coloration of the sample spotted thereon. This dry analysis element 12 comprises square mounts 12a made of plastic on both sides. Each of the mounts includes a measuring element 12b having a reagent layer. In the middle of the front surface of the mount 12a shown in FIG. 6A, a spotting hole 12c from which a part of the surface of the measuring element 12b is exposed is formed, and the sample is spotted in this hole. On the other hand, in the middle of the back surface of the mount 12a shown in FIG. 6B, a photometric hole 12d from which a part of the back surface of the measuring element 12b is exposed is formed, and the coloration of the sample in this region is measured by a photometer head 96 (mentioned later) of the biochemical analysis apparatus 1. More than one kind of calorimetric dry analysis elements 12 are provided which are the same in shape but different in measuring item according to the measuring element 12b constituted by a reagent (coating). Each colorimetric dry analysis element is added with a dot arrayed pattern 12e provided by coding element information including reagent type information (such as a measuring item number, a sample type number, and/or the like) and reagent lot information (such as production lot number and/or other unique numbers related to the production thereof).

The element information represented by the dot arrayed pattern 12e includes the reagent type information and the reagent lot information and provided at the center, in the widthwise direction, of the front and rear parts of the mount 12a on the rear surface of the dry analysis element 12 by dot printing. In the vicinity of the center photometric hole 12d, a barcode pattern 12f such as lateral stripes including the reagent type information but not including the reagent lot information is provided by printing. Further, a measuring item name 12g is printed on the mount 12a on the surface of the dry analysis element 12.

It should be noted that the barcode pattern 12f is provided in order to make the dry analysis element usable for conventional analysis apparatuses. The card reader 56 of the biochemical analysis apparatuses 1 is used for carrying out a measurement through the use of a conventional dry analysis element 12 not attached with reagent lot information and a magnetic card storing therein the relevant reagent lot information. Though not shown, an electrolytic dry analysis element is attached with element information by printing similar patterns 12e and 12f as those mentioned above.

As shown in FIG. 3, the sample tray 2 is circular in shape, and provided with a sample container 11 holding therein a sample, an element cartridge 13 holding therein unused dry analysis elements 12 (e.g., calorimetric dry analysis elements and electrolytic dry analysis elements), and consumables (e.g., nozzle tips 14, dilution containers 15, mixing cups 16, and reference solution containers 17). The sample container 11 is set in the sample tray via a sample adaptor 18, and a number of nozzle tips 14 are also set in the sample tray in a state in which the nozzle tips are held in a tip rack 19.

The spotting station 3 for spotting the delivered dry analysis element 12 with a sample such as plasma, whole blood, serum, urine or the like is disposed on an extended line from the centerline of the sample tray 2. At the spotting station 3, in the case of a calorimetric dry analysis element 12, a sample is spotted thereon by the spotting mechanism 6, while in the case of an electrolytic dry analysis element 12, a sample and reference solution are spotted thereon by the spotting mechanism 6. The tip disposal area 9 into which the nozzle tips 14 are discarded is disposed following and adjacent to the spotting station 3.

The first incubator 4 is circular in shape and disposed on the aforementioned extended line on a side of the tip disposal area 9 opposite the sample tray 2. The first incubator 4 holds therein a calorimetric dry analysis element 12, wherein the analysis element is held at a constant temperature for a predetermined time and then subjected to colorimetry measurement. The second incubator 5 (see FIG. 3) is disposed adjacent to the side of the spotting station 3, and holds therein an electrolytic dry analysis element 12, where the analysis element is incubated for a predetermined time and subjected to potentiometry measurement.

The element transfer mechanism 7 (see FIG. 4) has an element transfer member 71 (transfer bar) positioned within the sample tray 2. The element transfer member 71 transfers a dry analysis element 12 from the sample tray 2 to the spotting station 3 and in turn to the first incubator 4 along a linear element transfer path R (see FIG. 3) which extends between the center of the sample tray 2 and the center of the first incubator 4 through the spotting station 3 and the tip disposal area 9. The element transfer member 71 is slidably supported by a guide rod 38 and reciprocally moved by a driving mechanism (not shown). One end of the element transfer member 71 is slidingly engaged in a guide hole 34a of a vertical plate 34.

The transport mechanism 8, which also serves as the spotting station 3, is provided for transferring an electrolytic dry analysis element 12 from the spotting station 3 to the second incubator 5 in the direction perpendicular to the element transfer path R

The spotting mechanism 6 is provided at the upper part of the analysis apparatus. The spotting nozzle 45 is also capable of traveling along the same straight line as the aforementioned element transfer path R, and operates to spot the analysis element with the sample and reference solution, dilute the sample with the diluent, and mix the diluted sample. The spotting nozzle 45 has a nozzle tip 14 attached to the tip end thereof, and serves to suction/discharge the reference solution and the like with respect to the inside of the nozzle tip 14. The spotting nozzle 45 is provided with syringe means (not shown) which suctions and discharges the reference solution and the like. The used nozzle tip 14 is removed and dropped for disposal at the tip disposal area 9.

The first incubator 4 is provided with the element discarding mechanism 10 (see FIG. 3) which pushes the calorimetric dry analysis element 12 after measurement towards the central portion of the first incubator 4 and drops the element for disposal. The used element may be discarded by the aforementioned element transfer mechanism 7. Meanwhile, the electrolytic dry analysis element 12 after being subjected to the measurement in the second incubator 5 is discarded into a discarding hole 69 by the transport mechanism 8.

A blood filtering unit (not shown) for separating blood plasma from blood is provided beside the sample tray 2.

In the following, the construction of each section of the apparatus will be specifically described. The sample tray 2 comprises a rotary disk 21 which is rotated in opposite directions, and a disk-shaped non-rotatable part 22 disposed at the center part thereof.

As shown in FIG. 3, the rotary disk 21 includes: five sample mounting sections 23 (A-E) for holding via the sample adapter 18 a sample container 11 (e.g., blood-collecting tube) containing therein a sample; five element mounting sections 24, which are respectively positioned adjacent the sample mounting sections, for holding the element cartridge 13 that accommodates in a stacked form the unused dry analysis elements 12 usually including various types as required corresponding to a measuring item of each sample measurement; two tip mounting sections 25 for holding the tip rack 19 that includes nozzle tip holding holes for respectively receiving a number of nozzle tips 14; three diluent mounting section 26 for holding the diluent container 15 containing therein diluent, a cup mounting section 27 for holding a mixing cup 16 (a molded product provided with a plurality of cup-shaped recesses) used for mixing therein the diluent and sample. These sections are arranged along an arc.

The non-rotatable part 22 includes a reference solution mounting section 28 of hollow-cylindrical shape for holding therein the reference solution container 17 containing the reference solution. The reference mounting section 28 is located on the line extended from the element transfer path R within the range of the movement of the spotting nozzle 45 and provided with an anti-evaporation cap 35 (see FIG. 2) for opening and closing the opening of the reference solution container 17.

The anti-evaporation cap 35 is held and urged in the closing direction by a pivotable member 37, and the lower end of the pivotable member 37 is pivotally supported by the non-rotatable part 22. An upper end engagement portion 37a of the pivotable member 37 can be brought into contact with a bottom end corner 42a of a movable frame 42 of the spotting mechanism 6. The movable frame 42 approaches the pivotable member 37 for suctioning the reference solution such that the pivotable member is allowed to pivot towards its opening direction. Accordingly, the anti-evaporation cap 35 opens the reference solution container 17 and the spotting nozzle 45 is allowed for suction of the reference solution. In other states, the anti-evaporation cap 35 closes the opening of the reference solution container 17 to prevent evaporation of the reference solution, which inhibits degradation of the measurement accuracy due to the change in concentration of the reference solution.

The rotary disk 21 is supported at its perimeter by a support roller 31 and rotatably held at the central portion thereof by a supporting shaft (not shown). A timing belt is wound around the outer circumference of the rotary disk 21 and rotates the rotary disk 21 in opposite directions with the aid of a driving motor. The non-rotatable part 22 is non-rotatably mounted to the supporting shaft mentioned above.

As shown in FIG. 4, a plurality of unused dry analysis elements 12, which are usually arranged in a stacked form in a mixed state, are inserted in the element cartridge 13 from above. When the cartridge is mounted to the element mounting section 24, the lower end of the cartridge is held on a bottom wall 24a of the element mounting section 24, and the lower most dry analysis element 12 is positioned at the same level as that of the element transfer surface of the element transfer member 71. The front wall of the element cartridge has at the lower most part a port 13a which allows only a single analysis element 12 to pass through, while the rear wall thereof has an opening 13b in which the element transfer member 71 can penetrate.

Windows 13c and 24b are respectively formed in the bottom wall of the element cartridge 13 and the bottom wall 24a of the element mounting section 24, such that the element information attached to the bottom surface of the dry analysis element 12 can be read from below of the element cartridge 13.

A reading device 33 for reading element information represented by dot arrayed pattern 12e on a dry analysis element 12 is provided under the sample tray 2. This reading device 33 is, as shown in FIG. 5, placed just below the position to which the element cartridge 13 (element mounting section 24) accommodating therein a dry analysis element 12 used for measurement of the sample is moved when the sample container 11 (sample mounting section 23) is conveyed to a suction position on a spotting nozzle 45 moving path (element transfer path R) with the rotation of the rotary disk 21 from the element transferring position shown in FIG. 3 by the operation of the sample tray 2. That is, in this particular embodiment, the reading device 33 is placed at a rotational position of the element mounting section 24 with a phase angle shift by a phase pitch between the sample mounting section 23 and the element mounting section 24 out of the element transfer path R. The reading device 33 is shown with a part of the rotary disk 21 being cut away in FIG. 3, while the reading device 33 is shown below the element mounting section 24 located on the element transfer path R for convenience's sake.

The reading device 33 comprises a CCD (charge coupled device) camera suitable for use with dot pattern recording. Readout of the element information of a dry analysis element 12 by the reading device 33 is performed prior to suctioning the sample from the corresponding sample container 11 and transferring the dry analysis element 12. The reagent type information, the reagent lot information and the like can be known by reading a six-digit or four-digit number representing the element information attached to the dry analysis element 12. Further, the front and back surfaces and the forward and backward directions of the dry analysis element can be determined from the recorded pattern and the like. This enables detection of a setting failure and generation of a warning. Some measuring items require a diluent and a reference solution. Thus, a warning may be issued when consumables 14 to 17 therefor become out of stock, and/or when the sample type and the measuring item of the dry analysis element 12 are not matched. The function of handling the element information readout error will be described with reference to FIG. 7.

On the other hand, the sample adapter 18 is formed in a tubular shape, and the sample container 11 is inserted therein from above. The sample adapter 18 has an identification portion (not shown). Information such as a type (process information) of the sample, a type (size) of the sample container 11 and the like are set, then the identification of the sample is read at the start of the measurement by an identification sensor 30 (see FIG. 3), which is disposed on the outer circumference of the sample tray 2, in order to determine whether the sample is to be diluted, whether the blood plasma is to be filtered or the like. Subsequently, the liquid level variations associated with the size of the sample container 11 are calculated, and control depending thereto is performed. When filtering of blood plasma is necessary, the relevant sample container 11 is fitted in a sample adaptor 18, and a holder with a filter (not shown) is mounted on the sample container 11 via a spacer (not shown).

The spotting station 3 and the transport mechanism 8 have a long supporting table 61 which extends between the sample tray 2 and the first incubator 4 in the direction perpendicular to the element transfer path R, and a sliding frame 62 is provided on the supporting table 61. A first element retainer 63 with a spotting opening 63a (see FIG. 4) and a second element retainer 64 attached to the sliding frame 62 so that they are arranged adjacent to each other and they can move as one. A recess 63b through which the dry analysis element 12 move along the element transfer path R is provided in the bottom wall of the first element retainer 63 (also the second element retainer 64) on the side facing to the supporting table 61. A guide bar 65 guides one end of the sliding frame 62 which has a long slit 62a at the other end engaged with a pin 66. The sliding frame 62 is moved with a rack gear 62b being meshed with a driving gear 67 of a driving motor 68. The supporting table 61 has the second incubator 5 and a discarding hole 69.

As shown in FIG. 3, when the first element retainer 63 is positioned at the spotting station 3, the calorimetric dry analysis element 12 after subjected to spotting is pushed out and transferred to the first incubator 4 by the element transfer mechanism. On the other hand, when spotting onto the electrolytic dry analysis element 12 is performed, the sliding frame 62 is moved such that the dry analysis element 12 after subjected to spotting is slidingly moved on the supporting table 61 with the element being retained by the first element retainer 63, transferred to the second incubator 5, and subjected to the potentiometry. At this time, the second element retainer 64 is moved to the spotting station 3 (spotting position), and therefore, it is possible to spot the sample on the colorimetric dry analysis element 12 to be subsequently supplied, and to transfer the spotted element to the first incubator 4. After completion of the measurement in the second incubator 5, the sliding frame 62 is further moved such that the dry analysis element 12 after measurement is conveyed to and dropped into the discarding hole 69 for disposal.

Note that it is also possible that the second element retainer 64 is moved to the spotting station 3 when a calorimetric dry analysis element 12 and left there in advance, and the first element retainer 63 is moved to the spotting station 3 only when the electrolytic dry analysis element 12 is conveyed.

The spotting mechanism 6 (see FIG. 2) includes the movable frame 42 which is supported on a horizontal guide rail 41 of a stationary frame 40 so as to be horizontally movable. Two spotting nozzles 45 are mounted on the movable frame 42 so as to be vertically movable. A vertical guide rail 43 is fixed in the center of the movable frame 42, and two nozzle-fixing blocks 44 are arranged at opposed sides of the vertical guide rail 43 and slidably supported thereby. Upper ends of the spotting nozzles 45 are respectively fastened to the lower parts of the nozzle fixing blocks 44. Each of the nozzle-fixing blocks 44 has a shaft-shaped member which extends upward and is inserted through a drive transmission member 47. A compression spring interposed between the nozzle fixing block 44 and the drive transmission member 47 provides the nozzle tip 14 with an engaging force. The nozzle fixing block 44 is vertically movable together with the drive transmission member 47 as one, and when the nozzle tip 14 is fitted to the end of the spotting nozzle 45, the compression spring is compressed, which allows the drive transmission member 47 to move downward with respect to the nozzle fixing block 44. The drive transmission member 47 is fixed to a belt 50 which is tensed between upper and lower pulleys 49, and vertically moved in association with the movement of the belt 50 driven by a motor (not shown). A balance weight 51 is mounted on the outside of the belt 50 for preventing the spotting nozzle 45 from moving downward except during driving.

The horizontal travel and independent vertical movements of the spotting nozzles 45 are controlled by the fact that the movable frame 42 is horizontally traveled by a belt driving mechanism (not shown) and the two nozzle fixing blocks 44 are vertically moved independently of one another. In this way, the two spotting nozzles 45 are allowed to horizontally travel as one and vertically move independently of one another. For example, one of the spotting nozzles 45 is for the sample, and the other is for the diluent or the reference solution.

Each of the spotting nozzles 45 is formed in the shape of a rod including an air passage extending therethrough in the axial direction, and a pipette-shaped nozzle tip 14 is sealingly fitted to the lower end portion of the nozzle. These spotting nozzles 45 are respectively coupled to air tubes connected to syringe pumps (not shown) or the like, and a suction force and a discharge force are selectively supplied to each of the spotting nozzles 45. Further, the liquid surface of the sample or the like can be detected based on variation of the suction pressure.

The tip disposal area 9 comprises an upper member 81 and a lower member 82, and is positioned so as to vertically intersect with the transfer path R. A drop hole 83 having an oblong shape is provided in this tip disposal area 9 of the supporting table 61. The upper member 81 is fastened to the upper surface of the supporting table 61 and provided with an engagement cutout 84 just above the drop hole 83. Meanwhile, the lower member 82 is provided on the lower surface of the supporting table 61 so as to surround the lower part of the drop hole 83 and serves to guide a dropping nozzle tip 14.

The spotting nozzle 45 with which the nozzle tip 14 is fitted is first moved downward into the upper member 81, and then horizontally moved such that the engagement cutout 84 of the upper member 81 is engaged with the upper end of the nozzle tip 14. The spotting nozzle 45 is then moved upward, whereby the nozzle tip 14 is removed therefrom. The removed nozzle tip 14 is dropped through the drop hole 83 for disposal.

The first incubator 4 for making a colorimetry measurement comprises a toroidal-shaped rotary member 87 at a radially outward region thereof. The rotary member 87 has an inclined rotary pipe 88 fixed on the radially inward side of the lower surface of the rotary member. The lower part of the inclined rotary cylinder 88 is rotatably supported by a bearing 89 disposed below thereof, which allows the rotary member 87 to freely rotate. An upper member 90 is provided at the upper part of the rotary member 87 so that the upper member 90 can rotate integrally with the rotary member 87. The bottom surface of the upper member 90 is flat, and the upper surface of the rotary member 87 has a plurality of recesses (in the case of FIG. 2, thirteen recesses) spaced at predetermined intervals. Element chambers 91 in the form of a slit are formed between the members 87 and 90. Each element chamber 91 is provided so that the bottom surface thereof is positioned at the same level as that of the conveying surface. The hole of the inclined rotary cylinder 88 surrounds a discarding hole 92 for discarding the dry analysis elements 12 after measurement. The used dry analysis measurement 12 in the element chamber 91 is moved towards the center of the rotary member as it is, and dropped through the discarding hole 92 for disposal.

The upper member 90 comprises a heater (not shown) for incubating the dry analysis elements 12 within the element chamber 91 at a predetermined temperature by the temperature control thereby. The upper member 90 further comprises a retaining member 93 which, as shown in FIG. 4, faces the element chamber 91 and retains the mount of the dry analysis element 12 to prevent evaporation of the sample. A heat insulating cover 94 is provided on the upper surface of the upper member 90, and the entire first incubator 4 is covered with a light shielding cover 95. Further, a photometric opening 91a is formed in the center of the bottom surface of each element chamber 91 of the rotary member 87. The reflection density of the dry analysis element 12 is measured through the photometric opening 91a by a photometer head 96 disposed at the position shown in FIG. 2. The first incubator 4 is rotated in both directions by a belt mechanism (not shown).

The element discarding mechanism 10 comprises a discarding bar 101 which can advance into or withdraw from the element chamber 91 in a radial direction. The discarding bar 101 is fastened at the rear end to a horizontally running belt 102, and pushes out the measured dry analysis element 12 for disposal from the element chamber 91 depending on the movement of the belt 102 driven by a driving motor 103. A collection box for collecting the dry analysis elements 12 after measurement is provided under the discarding hole 92.

In the second incubator 5 for measuring the ion activity, a single element chamber is defined between the recess formed at the bottom of the first element retainer 63 of the aforementioned sliding frame 62 and the upper surface of a measurement body 97. The second incubator 5 is provided with a heater (not shown) so that the portion of the dry analysis element 12 where the ionic activity is measured is incubated at a predetermined temperature owing to temperature control of the heating means. Three potential measuring probe pairs 98 for measuring the ion activity are positioned in the side wall of the measurement body 97 so that they can be brought into contact with the ion selective electrodes of the electrolytic dry analysis element 12.

The blood plasma filtering unit (not shown) is inserted into the sample container (e.g., a blood-collecting tube) 11 held in the sample tray 2 and suctions plasma through a holder (not shown) with a glass fiber filter which is mounted on the upper end of the sample container, thereby separating plasma from the blood and holding the separated plasma in a cup formed at the top of the holder.

Operation and measurement condition settings of the biochemical analysis apparatus 1 as mentioned above are input through the control panel 55 provided on the cabinet 20. This control panel 55 (interface) comprises a display screen and operation buttons for providing various instructions with a finger touch of the user. Such operation buttons includes a start button, a stop button, a sample button, a consumables button, a manual-mode button, an emergency button, a calibration button, ten keys, and a print key. This control panel 55 is connected with a control system (not shown) in which analysis-processing features based on a control program registered therein are incorporated. The control system is adapted to select and start an automatic measurement operation, a manual measurement operation, an emergency measurement operation, a calibration operation, a print operation, or the like, and calculate the analysis result (constituent concentration) based on the measured value using analytical information corresponding to the reagent lot information. Then, the resultant data is printed by the printer 57, for example, for recording the result of measurement in a printed form, and confirming the set values.

FIG. 7 is a flowchart showing a process of reading the element information attached to the dry analysis element 12 through the use of the reading device 33.

After measurement is started, first, in step S1, the element information, i.e., the reagent type (measurement item) and reagent lot information, of the dry analysis element 12 is read. In other words, the element information represented by the dot arrayed pattern 12eattached to the dry analysis element 12 is read by the reading device 33, and thereby the reagent type/reagent lot information is input to the analysis apparatus.

In step S2, whether the reagent type is successfully read out is determined. If the answer in step S2 is YES and the reagent type has been successfully read out, whether the reagent lot of the reagent type is set to be disregarded is determined in step S3.

If the answer in step S3 is NO and calculation specific to the reagent lot information is performed to provide the analysis result, whether the reagent lot information is successfully read out is determined in step S4. If the answer in step in S4 is YES and the reagent lot information has been successfully read out, the registered analytical information is retrieved from the reagent lot information and the analysis result is calculated based on the registered analytical information in step S5. That is, the analytical information for the respective reagent lots has been entered in the memory of the analysis apparatus in advance, and relevant analytical information is thus retrieved according to the input reagent lot information. The measured value is corrected based thereon and the analysis result such as the constituent concentration of the sample is calculated.

If the answer in step S4 is NO and the reagent lot information has not been successfully read out, the analysis result is calculated based on one of the registered analytical information pieces corresponding to the respective reagent lots in step S6. Then, in step S7, a warning mark (warning information) is attached to the calculated result since there is a possibility that a different reagent lot information should have been used.

Though not shown, for the analysis result added with the warning mark, a re-calculation function is further provided in order to re-calculate the analysis result to obtain the exact value when the reagent lot is different. More specifically, when the user confirms the reagent lot, for example, by the container of the dry analysis element 12 and finds the reagent lot of the dry analysis element is different from the reagent lot used for calculation, the user inputs the correct reagent lot information and instructs the apparatus to perform re-calculation, as a result of which the analysis result of the correct reagent lot is obtained.

That is, the readout error handling processing is used to calculate the analysis result when a plurality of analytical information pieces is provided corresponding to the respective reagent lots of a single reagent type. The readout error handling processing comprises steps of registering the plurality of analytical information pieces in advance, selecting a proper analytical information piece based on the reagent lot information attached to the dry analysis element 12 to be used, and calculating the analysis result through the use of the proper analytical information piece. When the reagent lot information of the dry analysis element 12 is not successfully read out, the analysis result is calculated using one of the analytical information pieces corresponding to any of the reagent lots. If it is found that the reagent lot used for the calculation is different from that of the subjected dry analysis element, re-calculation is performed using the analytical information corresponding to the correct reagent lot by inputting the correct reagent lot information, and the correct analysis result is obtained.

On the other hand, if the answer in step S3 is YES and the reagent lot of the relevant reagent type has been set to be disregarded, the analysis result is calculated based on the stored analytical information which is appropriate for the subjected analysis element 12 in step S8. In other words, both when the reagent lot information is successfully read out and not successfully read out, the analysis result is calculated based on the analytical information provided for the respective types of dry analysis elements 12, irrespective of the presence of the reagent lot information.

The reagent type to be set to disregard the reagent lot as mentioned above is that whose reagent-lot-specific variations of the dry analysis elements 12 are negligible in terms of accuracy, and therefore the reagent lot information is unnecessary. The dry analysis element 12 is attached with lot information such as a lot number, for example, for manufacturing control, and the lot information is read out. The aforementioned feature enables the automatic analysis apparatus to prevent interruption of the measurement caused by occurrence of a readout error.

On the other hand, if the answer in step S2 is NO and therefore the reagent type has not been read out successfully, the analysis is interrupted in step S9.

In accordance with this embodiment, even when the reagent lot information is not read out successfully, the analysis result is calculated through the use of analytical information, which may be possibly not corresponding to the reagent lot, without interrupting the measurement, and if necessary, the analysis result can be corrected by performing re-calculation processing. This obviates repetitive spotting and measurement of the sample. In regard to the dry analysis elements whose reagent lot might be disregarded, the fact is clarified and used for setting in order to avoid influences exerted by a readout error.

What is claimed is:

1. An analysis apparatus for spotting a sample on the dry analysis element and analyzing the sample for its composition by measurement and calculation based on analytical information corresponding to the element information, the analysis apparatus comprising a reading device for reading out element information attached to a dry analysis element, wherein:
the element information attached to the dry analysis element includes at least reagent lot information for correcting reagent-lot-specific variations; and
the analysis apparatus has an error handling function to calculate the analysis result based on pre-obtained analytical information corresponding to the reagent lot and add the a caution mark to the analysis result to attract attention, when the reagent lot information is not read out successfully.

2. An automatic analysis apparatus for spotting a sample on the dry analysis element and analyzing the sample for its composition by measurement and calculation based on analytical information corresponding to the element information, the automatic analysis apparatus comprising a reading device for reading out element information attached to a dry analysis element, wherein:
the element information attached to the dry analysis element includes reagent type information defining a measuring item, and reagent lot information for correcting reagent-lot-specific variations;
the reading device can read out the reagent type information during reading the element information; and
the automatic analysis apparatus has an error handling function to calculate the analysis result based on pre-obtained analytical information corresponding to the reagent lot and add the a caution mark to the analysis result to attract attention, when the reagent lot information is not read out successfully.

3. An analysis apparatus according to claim 1, further having a re-calculation function to re-calculate the analysis result when normal reagent lot information is input to correct the analysis result to which the caution mark was added.

4. An analysis apparatus according to claim 1, wherein the dry analysis element is attached with the element information in the form of an arrayed pattern of dots.

5. An automatic analysis apparatus for spotting a sample on the dry analysis element and analyzing the sample for its composition by measurement and calculation based on analytical information corresponding to the element information, the automatic analysis apparatus comprising a reading device for reading out element information attached to a dry analysis element, wherein:
the element information attached to the dry analysis element includes reagent type information defining a measuring item, and reagent lot information for correcting reagent-lot-specific variations;
the reading device can read out the reagent type information during reading the element information; and
the automatic analysis apparatus has an error handling function to calculate the analysis result based on pre-obtained analytical information corresponding to the reagent lot and add the a caution mark to the analysis result to attract attention, when the reagent lot information is not read out successfully.

6. An automatic analysis apparatus according to claim 5, further having a re-calculation function to re-calculate the analysis result when normal reagent lot information is input to correct the analysis result to which the caution mark was added.

7. An automatic analysis apparatus according to claim 5, wherein the dry analysis element is attached with the element information in the form of an arrayed pattern of dots.

8. An automatic analysis apparatus for spotting a sample on a dry analysis element and analyzing the sample for its composition by measurement and calculation based on analytical information corresponding to element information attached to the dry analysis element, the automatic analysis apparatus comprising a reading device for reading out the element information, wherein:
the element information attached to the dry analysis element includes reagent type information defining a measuring item, and reagent lot information for correcting reagent-lot-specific variations;
the element information readout processing by the reading device is previously set to disregard a reagent lot of a specific reagent type; and
the automatic analysis apparatus further has a function to subject the dry analysis element, from which the reading device reads the reagent type information designated to disregard the reagent lot, to calculation processing for determining the analysis result based on pre-obtained analytical information irrespective of the condition when the reagent lot information is read.

9. An automatic analysis apparatus according to claim 8, wherein the dry analysis element is attached with the element information of the dry analysis element in the form of an arrayed pattern of dots.
